(19) United States
(12) Patent Application Publication
(10) Pub. No.: US 2005/0259422 A1
(43) Pub. Date: Nov. 24, 2005

(54) Moveable revolution structure

(76) Inventor: Wenman Li, XinXiang (CN)

Correspondence Address: Kao H. Lu, 686 Lawson Ave., Havertown, PA, 19083, US

(21) Appl. No.: 10/850,000

(22) Filed: May 20, 2004

(51) Int. Cl. F21V 21/26

(52) U.S. Cl. 362/269; 362/285

(57) ABSTRACT

This invention is a revolution structure for mounting a light fixture that can be rotated up and down, as well as left and right. This invention comprises a light box mounting plate, a supporter and a revolution axis. The top of a revolution axis is inserted in a light box mounting plate and the bottom of a revolution axis is inserted into a hole in a supporter. A steel ball located between a mounting plate and a revolution axis is used to align a proper position that is fastened by a button-head screw. A screw nut is used to fasten the bottom of a revolution axis and a supporter. A light box that has been installed with this structure allows changing its angle and position after installation. This structure is very simple and easy to use.

### BACKGROUND OF THE INVENTION

1. Field of the Invention

This invention relates to installation of a light fixture, more particularly, this invention is a revolution structure that can be rotated up and down and be revolved left and right.

2. Description of the Related Art

Currently, people use a simple fixed plate as a mounting structure to install a light fixture. Although it is simple and cheap, but once the light fixture is installed, the light box is no longer moveable. It can only face one direction. However, a light fixture usually has its directional property. Thus, it limits possibly installation locations as well as positions. Especially sometimes there is a need for changing the light focus directions or moving the light area a little, it requires removing the light box and the traditional mounting plate and re-installing them. It is cumbersome and may cause some unnecessary trouble for users. This problem can be resolved if there is a mounting structure that can change angles and locations in some degree after a light fixture is installed.

### SUMMARY OF THE INVENTION

The objective of this invention is to improve the current design by providing a moveable mounting structure so that an installed light box can be moved up and down as well as be rotated left and right.

This invention comprises a light box mounting plate, a supporter and a revolution axis. One end of the revolution axis is inserted in a mounting plate and the other end of a revolution axis is inserted into a hole of a supporter. A steel ball is used between a mounting plate and a revolution axis to line up at an appropriate position and a button-head screw is used to latch down the mounting plate and the revolution axis. Meantime a screw nut is used to fasten the bottom end of a revolution axis and a supporter.

Once above design is adopted, even a light box is permanently installed on a mounting plate, a mounting plate can still be rotated up and down around a revolution axis. Furthermore, a revolution axis can also be revolved left and right around a supporter. Thus, a light box can change its position and rotate its angle in certain degree after installation. Additionally, this invention has a simple structure and low costs.

### BRIEF DESCRIPTION OF DRAWINGS

FIG. 1 is a cross section view of this invention.

### DETAIL DESCRIPTION OF THE INVENTION

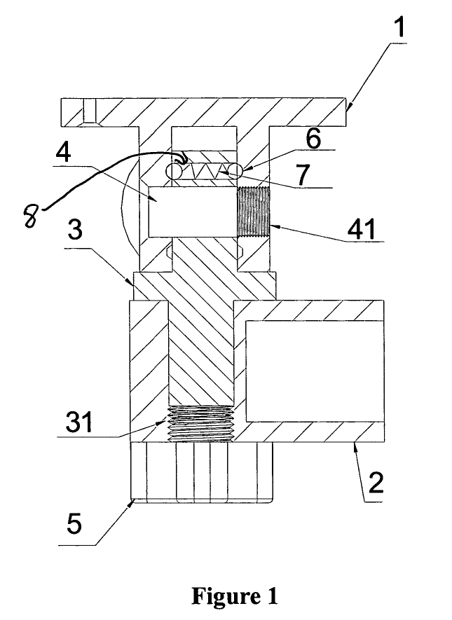

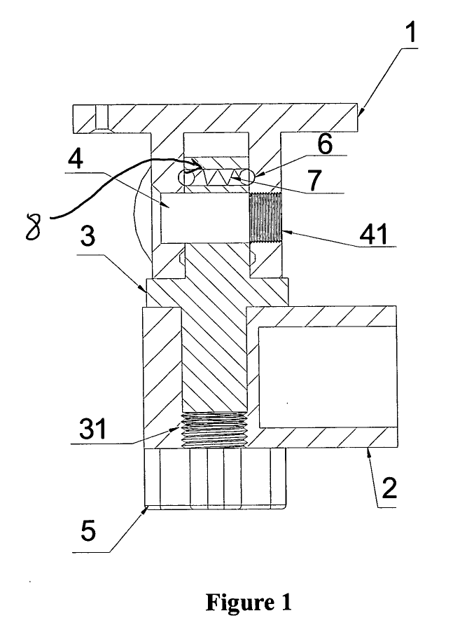

As shown in FIG. 1, this invention comprises mainly a light box mounting plate (1) and a supporter (2). It also has a revolution axis (3). The top of a revolution axis is inserted in a mounting plate (1) and the bottom of a revolution axis is inserted into a hole of a supporter (2). A steel ball (6) that is located between a light box mounting plate (1) and a revolution axis is used to line up them at an appropriate position. A button-head screw (4) is used to latch down a mounting plate and a revolution axis at a desired position. A screw nut (5) is used to latch down the bottom of a revolution axis and a supporter.

FIG. 1 depicts a screw thread (31) at the bottom of a revolution axis. A screw nut (5) is located at outside of a supporter (2) for tightening up the revolution axis via a screw thread (31) so that a revolution axis does not fall off from a supporter. Alternatively, an alignment pin can also be used for this purpose. A button-head screw (4) goes through a mounting plate (1) and the top end of a revolution axis (3), and then is tightened with a mounting plate via a screw thread (41). It can also be tightened via a button-head screw (4). Steel balls (6) are located between a mounting plate and a revolution axis. These steel balls are used to line up a mounting plate and a revolution axis at an appropriate position through the pressure from a spring (7).

In an application, this design can be installed at an appropriate place with a supporter (2). A light fixture can be fastened on a light box mounting plate (1). After installation, if there is a need of changing position of a light box, one can manually adjust a screw nut (5) to revolve a revolution axis (3) left or right along a supporter (2). One can also adjust a button-head screw (4) to rotate a mounting plate (1) up or down along a revolution axis (3). This allows changing a light box to a desired angle and position after installation.

1. A moveable revolution structure comprises:
a light box mounting plate (1), a supporter (2), where a revolution axis (3) of which the one end is inserted to a light box mounting plate (1) and the other end is inserted into a hole in a supporter (2).

2. The moveable revolution structure according to claim 1, wherein a revolution axis has a hole at the top where there is a spring (7) in the hole and a steel ball (6) at each end of a spring (7).

3. A moveable revolution structure according to claim 1, wherein a light box mounting plate having several concave spherical surfaces (8) that are matched exactly with the spherical surface of steel balls (6) for alignment.

4. A moveable revolution structure according to claim 1, wherein a light box mounting plate (1) and a revolution axis (3) are fastened together by a button-head screw (4).

5. A moveable revolution structure according to claim 1, wherein a supporter (2) and a revolution axis (3) are fastened via a screw thread (31) at the bottom of a revolution axis and a screw nut (5).
